(19) United States
(12) Patent Application Publication
(10) Pub. No.: US 2025/0180427 A1
(43) Pub. Date: Jun. 5, 2025

(54) FOOT SWITCH WITH A HOUSING AND METHOD FOR CHECKING THE TIGHTNESS OF A HOUSING

(71) Applicant: STEUTE TECHNOLOGIES GMBH & CO. KG, Löhne (DE)

(72) Inventors: Christof GERHARDY, Bad Oeynhausen (DE); Marc SCHMIDT, Hiddenhausen (DE)

(21) Appl. No.: 18/844,549

(22) PCT Filed: Mar. 13, 2023
(86) PCT No.: PCT/EP2023/056362

§ 371 Date: Sep. 6, 2024

(30) Foreign Application Priority Data
Mar. 16, 2022 (DE) 10 2022 106 099.3

(51) Int. Cl. G01M 3/32

(52) U.S. Cl. CPC G01M 3/3236

(57) ABSTRACT

A housing with an internal volume is leak tested by changing an internal pressure in the internal volume of the housing and determining a first internal pressure and a first temperature. A second internal pressure and a second temperature are determined. It is then determined whether an absolute value of a difference between the second internal pressure and the first internal pressure, considering a difference between the first and second temperatures, is above a threshold value. A signal representing the result of the previous step is output.

### BACKGROUND AND SUMMARY OF THE INVENTION

Exemplary embodiments of the invention relate to a method for checking the tightness of a housing with an at least partially air-filled internal volume and, in particular to a housing of a foot switch intended for use in the medical field, as well as to a foot switch with a housing.

For a wide variety of reasons, it is often necessary to provide switches with sealed housings or to accommodate switching elements in such housings. For example, in the medical field, switches are often exposed to liquids, particularly during cleaning, which, if they penetrate into the interior of the housing, can cause the switch to malfunction.

Common methods for testing the tightness of an enclosure usually utilize external testing equipment. Such test equipment usually requires that the enclosure, and therefore usually the entire switch, is connected to or inserted into this test equipment during the test. Examples of this are pumps that are connected to the inside of the housing and put it under test pressure, or test chambers in which the housing is pressurized from the outside. For this purpose, the operation of the switch is interrupted and/or the switch housing is removed from its operating environment. On the one hand, this means a certain amount of testing work and, on the other hand, it can happen that a leak that has occurred during operation remains undetected for a long time because such tests can only be carried out at long intervals due to the testing work involved or are not carried out from the outset. Methods that use external test equipment are therefore generally less suitable for frequently checking the tightness of a switch housing or recognizing an existing leak promptly.

A further disadvantage of methods with external test equipment is that it is not possible to detect moisture ingress due to the design, as the housing would have to be opened for this.

The disadvantages mentioned above can generally be avoided by checking a housing for leaks using methods that work with internal sensors. This creates the possibility of spontaneous, even ad-hoc testing at the point of use.

The method described in patent specification U.S. Pat. No. 10,408,703 B2, for example, was proposed to solve this problem. Here, the deflection of an actuating element together with its seal is recorded, whereby the actuating element and the seal in the present case are designed in one piece and form one of the housing walls. The deflection is set in relation to the expected change in the internal pressure of the housing. If the actual pressure change does not correspond to the expected one, the deviation can be used as the basis of a signal that can be used to indicate the leak appropriately.

Although a spontaneous leak test is possible with this method, it may provide incorrect test results if the ambient conditions—in particular the ambient temperature—fluctuate greatly.

An incorrect test result is also possible if liquid has already penetrated the housing. The volume of air originally present inside the housing is then reduced by the volume of liquid that has penetrated. When using this method, the measured pressure change can be influenced in such a way that it corresponds to that of a sealed housing despite the existing leak.

Overall, this method is therefore not suitable for checking the tightness of housings of foot switches intended for use in the medical field.

Based on this, it is a task of the present invention to describe a method for leak testing a housing that can also be carried out regularly in practice and reliably detects a leak even under varying ambient conditions. It is a further task to describe a housing of a switch that is suitable for implementing the method.

In accordance with the invention, it is proposed for checking the tightness of housings, in particular housings of foot switches intended for use in the medical field, to evaluate not only the pressure change but also the temperature and possibly the humidity inside the housing.

This can be done by analyzing the measured values of corresponding pressure, temperature, and possibly also humidity sensors, which are arranged inside a foot switch housing, whereby at least two of these sensors can also be designed in one piece, i.e., integrated into a single component.

Specifically, according to the invention, an internal pressure of the air in the housing is first changed. A first internal pressure and a first temperature are then determined and, after a waiting time, a second internal pressure and a second temperature are determined. It is then determined whether an absolute value of a difference between the second internal pressure and the first internal pressure is above a threshold value, taking into account a difference between the first and the second temperature, and a signal is output which reflects the result of the previous step of determining. In this way, it is determined whether the pressure change is maintained in the housing. If this is not the case, this indicates a leak in the housing. The waiting time can be in the range of a few seconds, for example.

At least two pressure measurements are required to measure whether the internal pressure changes within the waiting time. In one embodiment of the method, it is also possible to measure the pressure and possibly also the temperature repeatedly within a predetermined period of time. It can then be determined whether the measured values are essentially constant over the specified period of time. If this is not the case, it is signaled that the housing is leaking.

The method therefore utilizes a deliberately induced pressure change and then measures a pressure curve that is compared with the expected constant pressure curve. In order to prevent falsification of the result, the influence of a possible change in temperature is also taken into account.

The change in pressure can, for example, be brought about by a deliberate change in volume, for example by using an actuating element on the housing, the actuation of which changes the internal volume of the housing.

It may also be possible to determine a humidity value inside the housing. In particular, a humidity value above a predefined threshold value of e.g., 80-90% relative humidity indicates that moisture that has already entered the housing could falsify the result of the test procedure, so that a leak is signaled in this case. This additional consideration of the humidity value can further increase the reliability of the test procedure.

A foot switch according to the invention, in particular for a medical device, has a sealed housing with an at least partially air-filled inner volume and at least one actuating element, the actuation of which changes the inner volume of the housing. It also has at least one pressure sensor for measuring a pressure in the internal volume and a temperature sensor as well as an evaluation unit. The foot switch is characterized by the fact that the evaluation unit is set up to carry out a method according to the invention.

In a method according to the invention that utilizes the aforementioned measured values, for example, restarting the power supply to the switch after an interruption constitutes an event that triggers the leak test, whereby the interruption may be caused by an exchange of a corresponding power source, for example an accumulator or a battery, which in turn requires at least part of the foot switch housing to be opened and then closed. After the power supply has been restored, the user is prompted, for example by a light indicator, to press a predetermined actuating element, e.g., a button or a pedal of the foot control, for a predetermined time, for example a few seconds. The actuating element is designed in such a way that its actuation reduces the internal volume of the foot control. For example, the actuating element can have a calotte whose enclosed volume is connected to the remaining internal volume of the foot control and which is deformed during actuation. The actuation-induced deformation reduces the total internal volume of the foot switch by a predetermined amount. The course of the pressure, which increases as a result and decreases again after the actuating element is released, is observed, whereby any temperature change occurring during the test period is recorded and taken into account. If the pressures measured during actuation and over a similarly long period after the actuating element is released show an essentially constant curve, the switch is considered to be tight. The test procedure can also be triggered by events other than a battery change, e.g., when the foot switch is put into operation after a long break or at regular intervals.

In a further development of the procedure, it is also possible to check whether the humidity does not exceed a specified limit value. This ensures that any penetration of liquids into the interior of the switch during the opening of the switch or due to a leak is recognized.

If the switch is leaking and/or the ingress of liquid is detected, a corresponding signal is emitted and displayed in a suitable manner.

### BRIEF DESCRIPTION OF THE DRAWING FIGURES

The invention is explained in more detail below by means of an example embodiment with the aid of figures. The figures show:

FIG. 1 a partial view of a foot switch in which the method according to the invention is used, with the voltage source compartment open;

FIG. 2 a sectional view of a push-button switch assembly of the foot switch according to FIG. 1 in an unactuated state;

FIG. 3 a general view of the foot switch according to FIG. 1 with the voltage source compartment closed, an control lamp illuminated and two push-button switch assemblies according to FIG. 3, one of which is in an actuated state;

FIG. 4 a partial sectional view through the foot switch according to FIG. 1-3 with the actuated push-button switch assembly and an arrangement of sensors;

FIG. 5 a flow chart of an embodiment of the method according to the invention;

FIG. 6 a curve of the internal pressure of a foot switch according to FIG. 1-4 during a test cycle according to FIG. 5 with a sealed foot switch; and

FIG. 7 a curve of the internal pressure of a foot switch according to FIG. 1-4 during a test cycle according to FIG. 5 with a leaky foot switch.

### DETAILED DESCRIPTION

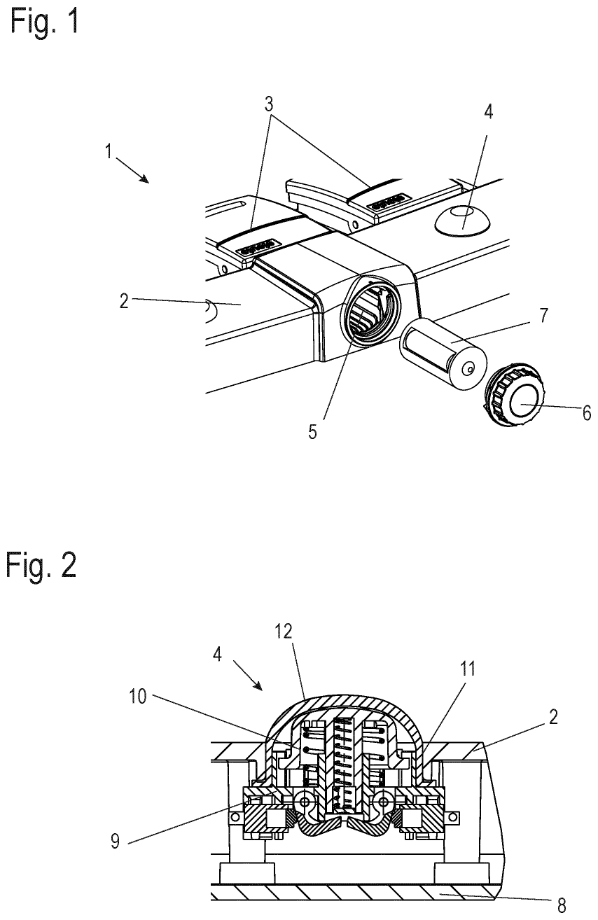

FIG. 1 shows a partial view of a foot switch 1 for use in the medical field with a housing 2, in this case several pedals 3, and one of several push-button switch assemblies 4, in which the method according to the invention is used. Also shown is the open power source compartment 5 with the removed compartment cover 6 and the removed power source 7.

FIG. 2 shows a sectional view of one of the push-button switch assemblies 4 according to FIG. 1 in an inoperative state. The housing 2 is sealed fluid-tight on the underside by a base plate 8. Push-button switch assemblies 4 mounted in the housing 2 each consist of a push-button switch 9 with a button 10 and a calotte 12, which closes the housing opening 11 required for the push-button switch assembly 4 in order to seal the interior of the foot switch 1 to the outside. The pedals 3 can each be coupled to a pedal switch assembly in a similar way to the button 10.

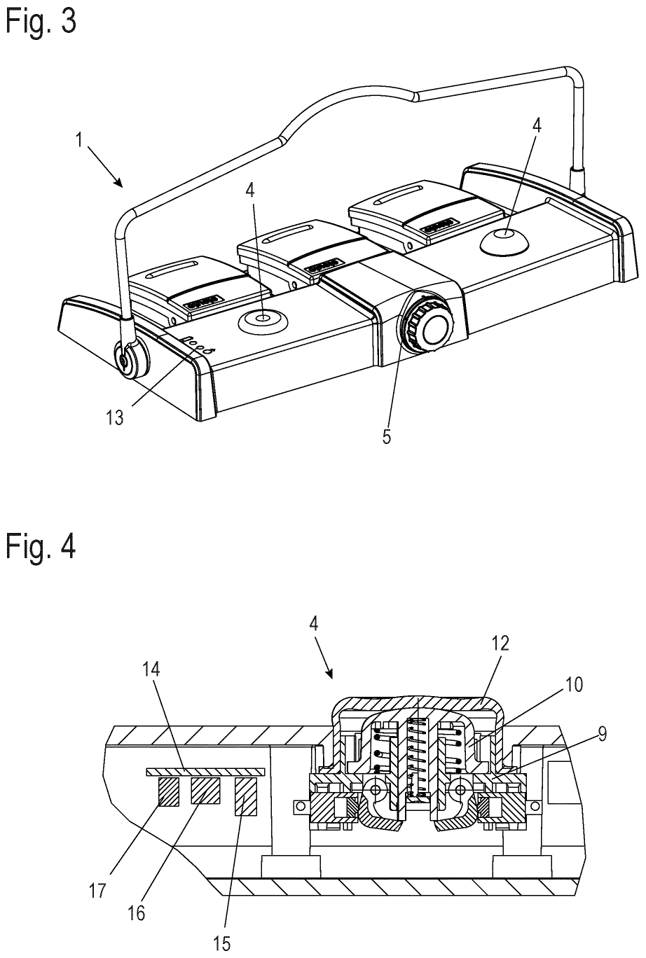

FIG. 3 shows an overall view of the foot switch 1 according to FIG. 1 with closed power source compartment 5, an illuminated control lamp 13 and two push-button switch assemblies 4 according to FIG. 3, one of which is in the actuated state.

FIG. 4 shows a partial sectional view through the foot switch 1 according to FIGS. 1-3, including a section through the actuated push-button switch assembly 4 according to FIG. 3. It can be seen how the depression of the button 10 of the push-button switch 9 required for actuation requires the calotte 12 to be deformed. This deformation causes a reduction in the internal volume of the foot switch 1 and thus an increase in the internal pressure. A printed circuit board 14 with sensors 15, 16, and 17 for measuring internal pressure, humidity, and temperature can also be seen, whereby at least two of these sensors can also be designed in one piece. An evaluation unit, which is not visible here, is also arranged on the printed circuit board, which reads out the sensors 15-17 and which is set up, e.g., with the aid of a microcontroller, to carry out the process described below.

Alternatively, actuation of one of the pedals 3 could also be requested if its actuation also changes the internal volume of the housing 2.

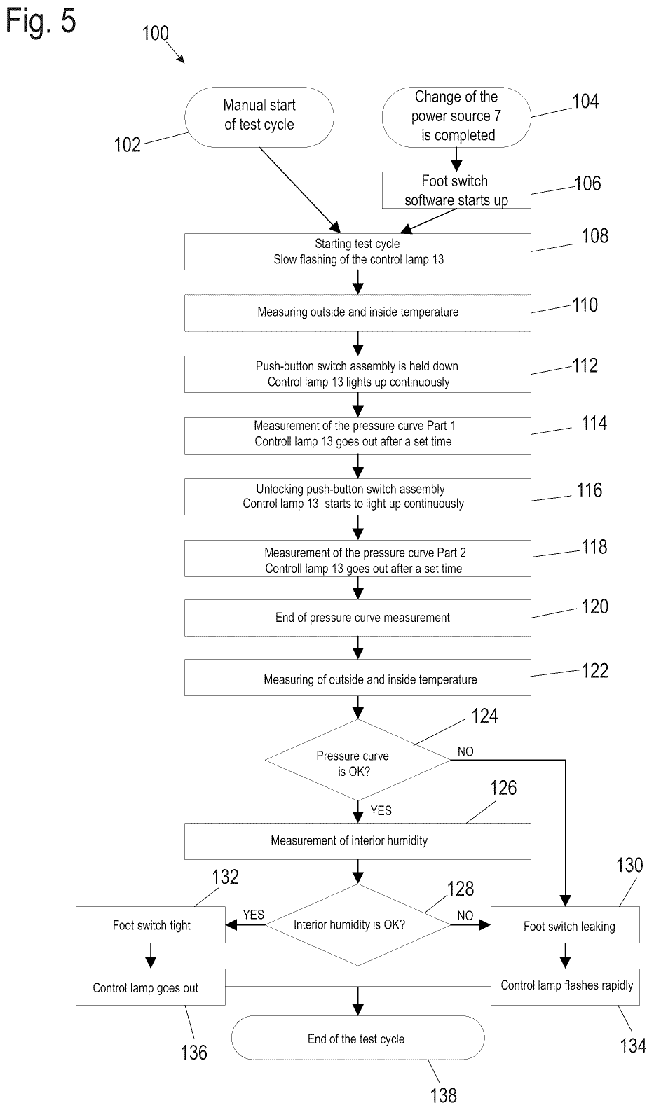

FIG. 5 shows a flow chart 100 of an embodiment of the leak test method according to the invention. The test cycle can be started in a suitable manner manually—step 102—, for example by actuating a corresponding switch not described in detail here or by a corresponding software command not described in detail here, or automatically by a specific event, for example by a completed change of the power source 7—step 104—, which is followed by the software of the foot switch starting up—step 106.

The start of the test cycle is marked by the slow flashing of the control lamp 13—step 108. Firstly, in step 110, the outside temperature is measured by a suitable sensor and the inside temperature by the sensor 17. Furthermore, the flashing of the control lamp 13 prompts the user to press and hold at least one of the push-button switch assemblies 4, whereupon the control lamp 13 begins to light up continuously—step 112.

This starts step 114, part 1 of the measurement of the pressure curve inside the switch by the pressure sensor 15. After the time specified for part 1 of the pressure curve measurement, the control lamp 13 goes out, prompting the user to release the button of the push-button switch assembly 4. The control lamp 13 then starts to light up continuously again—step 116—which starts step 118, part 2 of the measurement of the pressure curve inside the switch by the pressure sensor 15. After the time specified for part 2 of the pressure curve measurement, the control lamp 13 goes out again. This concludes the pressure profile measurement—step 120.

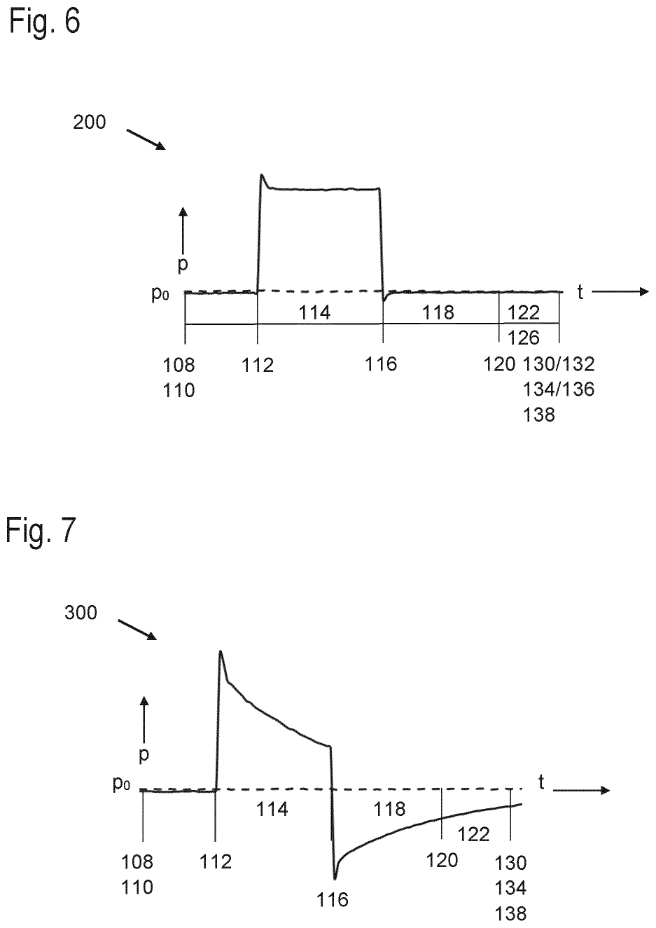

In step 122, the outside and inside temperatures are measured again in the same way as in step 110 and compared with the values from step 110. Any differences in these values are used to adjust, correct, or weight the measured pressure curve if necessary. Step 124 then checks whether or not the pressure curve fulfils the specified criteria (see FIGS. 6 and 7).

If this is not the case, the foot switch 1 is assessed as leaking in step 130. To indicate this, the control lamp 13 starts to flash rapidly—step 134—and the test cycle ends with step 138.

If, on the other hand, the pressure curve according to step 124 is OK, the humidity of the interior of the foot switch 1 is measured by the humidity sensor 16 in step 126.

In step 128, the measured humidity is compared with a predetermined maximum value, whereby this maximum value can be, for example, 80% relative humidity or more, but in particular 90% relative humidity or more. If the measured humidity exceeds the predetermined maximum value, it is assumed that moisture or liquid has penetrated into the interior of the foot switch, whereupon the foot switch is considered to be leaking in step 130. To indicate this, the control lamp 13 starts to flash rapidly—step 134—and the test cycle ends with step 138.

If, on the other hand, the humidity is OK according to step 128, the foot switch 1 is assessed as tight in step 132. This is indicated by the control lamp 13 going out in step 136, and the test cycle ends with step 138.

FIG. 6 shows a curve 200 of the internal pressure of a foot switch according to FIGS. 1-4 during a test cycle according to FIG. 5 with an essentially tight foot switch. The other reference signs correspond to the steps of the flow chart according to FIG. 5. At the beginning, which corresponds to steps 108 and 110, the internal pressure of the housing has the initial value p0. As soon as the push-button switch assembly 4 is actuated from step 112 and its button is held down, the pressure assumes an essentially constant higher value.

If, at the end of part 1 of the pressure curve measurement—step 114—the push-button switch assembly 4 is released again, the internal pressure essentially drops back to the initial pressure p0 when the foot switch 1 is essentially sealed and remains essentially at this value during part 2 of the pressure curve measurement—step 118—which begins after step 116, and thereafter.

Such a pressure curve is evaluated as “OK” in step 124.

FIG. 7 shows a curve 300 of the internal pressure of a foot switch according to FIGS. 1-4 during a test cycle according to FIG. 5 with a leaking foot switch. The other reference signs correspond to the steps of the flow chart in FIG. 5. At the beginning, which corresponds to steps 108 and 110, the internal pressure of the housing has the initial value p0. As soon as the push-button switch assembly 4 is actuated from step 112 and its button is held down, the pressure initially assumes a higher value, but drops more or less sharply over time depending on the severity of the leak.

If, at the end of part 1 of the pressure profile measurement—step 114—the push-button switch assembly 4 is released again, the internal pressure drops by approximately the amount of the initial pressure increase to a pressure below p0 when the foot switch 1 is leaking, and then, in the course of part 2 of the pressure profile measurement—step 118—which begins after step 116, it approaches the initial pressure p0 again to a greater or lesser extent over time, depending on the severity of the leak.

If the pressure drop in step 114 or the pressure increase in step 118 exceeds a predetermined limit value not shown here, the pressure curve is evaluated as “not OK” in step 124.

In addition to the embodiment example given here, other embodiments of the method are also obvious to the average skilled person. For example, the increase in pressure inside the housing carried out for testing purposes can be generated by an increase in the internal temperature instead of by reducing the internal volume, for example by heating an accumulator located inside during the charging process. In mathematical terms, the heating causes an increase in the internal pressure according to the general gas equation. Deviations from this indicate a leak. A separate humidity measurement can also be carried out here.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SYMBOLS

1 Foot switch
2 Housing
3 Pedal
4 Push-button switch assembly
Power source compartment
6 Cover for power source compartment
7 Power source
8 Base plate
9 Push-button switch
Button
11 Housing opening
12 Calotte
13 Control lamp
14 Circuit board
Pressure sensor
16 Humidity sensor
17 Temperature sensor
100 Flow chart
101-199 Process steps
200 Pressure curve with an essentially tight foot switch
300 Pressure curve with leaky foot switch

1-11. (canceled)

12. A method for leak testing a housing, wherein the housing has an at internal volume that is at least partially air-filled, the method comprising:
changing an internal pressure in the internal volume of the housing;
determining a first internal pressure and a first temperature;
determining a second internal pressure and a second temperature;
determining whether an absolute value of a difference between the second internal pressure and the first internal pressure, accounting for a difference between the first and second temperatures, is above a threshold value; and
outputting a signal representing whether or not the absolute value of the different between the second internal pressure and the first internal pressure is above the threshold value.

13. The method of claim 12, wherein the internal pressure is changed by changing the internal volume by a differential volume.

14. The method of claim 12, wherein internal pressure and temperature are repeatedly measured to determine the absolute value of a pressure difference.

15. The method of claim 12, wherein the housing is a housing of a foot switch, wherein the changing of the internal volume is performed by actuating a button or a pedal of the foot switch.

16. The method of claim 12, wherein the first and the second temperature are an internal temperature inside the housing, are an external temperature outside the housing, or are a temperature of the housing.

17. The method of claim 12, further comprising:
determining a humidity value inside the housing; and
outputting a signal that is dependent on the determined humidity value.

18. The method of claim 12, wherein the method is performed responsive to a connection or change of a power source of the foot switch.

19. A foot switch comprising:
a sealed housing with an inner volume that is at least partially air-filled;
at least one button or a pedal, wherein the at least one button or the pedal is configured so that actuation of the at least one button or the pedal changes the inner volume of the housing;
at least one pressure sensor configured to measure a pressure in the inner volume;
a temperature sensor; and
an evaluation unit configured, when the internal pressure in the internal volume of the housing is changed by actuation of the at least one button or the pedal, to
determine a first internal pressure and a first temperature;
determine a second internal pressure and a second temperature;
determine whether an absolute value of a difference between the second internal pressure and the first internal pressure, accounting for a difference between the first and second temperatures, is above a threshold value; and
output a signal representing whether or not the absolute value of the different between the second internal pressure and the first internal pressure is above the threshold value.

20. The foot switch of claim 19, further comprising:
a calotte with an inner volume that is pneumatically coupled to the inner volume of the housing or is part of the inner volume of the housing, wherein the calotte is deformable when the at least one button or the pedal is actuated.

21. The foot switch of claim 19, further comprising:
a humidity sensor configured to detect a humidity value inside the housing.

22. The foot switch of claim 21, wherein at least two of the at least one pressure sensor, the temperature sensor, and the humidity sensor are a single integrated component.
